(19) United States
(12) Patent Application Publication
(10) Pub. No.: US 2026/0264710 A1
(43) Pub. Date: Sep. 10, 2026

(54) VEHICLE CONTROL DEVICE, VEHICLE, AND VEHICLE CONTROL METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Tadashi OMACHI, Tokyo (JP); Shingo MORISHITA, Tokyo (JP); Yuki TEZUKA, Toyota-shi (JP); Koichi GUNYA, Obu-shi (JP)

(21) Appl. No.: 19/463,780

(22) Filed: Jan. 29, 2026

(30) Foreign Application Priority Data
Feb. 4, 2025 (JP) 2025-016972

(51) Int. Cl. B60W 50/14; B60W 30/12; B60W 50/08; B62D 15/02

(52) U.S. Cl. CPC B60W 50/14; B60W 30/12; B60W 50/082; B62D 15/029; B60W 2520/10; B60W 2552/10; B60W 2554/4041; B60W 2554/4042

(57) ABSTRACT

A vehicle includes a steering wheel, an adjacent lane sensor, and a notification device. The adjacent lane sensor detects another vehicle traveling in an adjacent lane that is adjacent to an own vehicle lane in which an own vehicle is traveling. The notification device notifies a request to a driver of the own vehicle. A vehicle control device performs hands-off control that causes the own vehicle to travel in a hands-off state in which the driver is not holding the steering wheel, and outputs a hands-on request to the notification device on the basis that the hands-off control is being performed and a speed of the other vehicle detected by the adjacent lane sensor is higher than a speed of the own vehicle, the hands-on request requesting transition to a hands-on state in which the driver is holding the steering wheel.

### CROSS-REFERENCE TO RELATED APPLICATION

This application is based on and claims the benefit of priority from earlier Japanese Patent Application No. 2025-016972 filed Feb. 4, 2025, the description of which is incorporated herein by reference.

### BACKGROUND OF THE INVENTION

### Technical Field

The present disclosure relates to a vehicle control device performing hands-off control and a vehicle control method.

### Background Art

For example, there is a vehicle control device that notifies a hands-on request in a case where future lateral acceleration is greater than a threshold.

### SUMMARY

In the present disclosure, provided is a vehicle control device as the following.

The vehicle control device applicable to a vehicle includes:
at least one of (i) a circuit and (ii) a processor with a memory storing computer program code executable by the processor, the at least one of the circuit and the processor configured to cause the vehicle control device to:
perform hands-off control that causes an own vehicle to travel in a hands-off state in which a driver is not holding a steering wheel; and
output a hands-on request to a notification device included in the vehicle on a basis that (i) the hands-off control is being performed and (ii) other vehicle speed is higher than own vehicle speed, the other vehicle speed being a speed of the other vehicle, the own vehicle speed being a speed of the own vehicle, the hands-on request requesting transition to a hands-on state in which the driver is holding the steering wheel.

In the present disclosure, also provided is a vehicle control method as follows.

The vehicle control method for a vehicle includes:
performing hands-off control that causes an own vehicle to travel in a hands-off state in which a driver is not holding a steering wheel; and
outputting a hands-on request to a notification device included in the vehicle on a basis that (i) the hands-off control is being performed and (ii) other vehicle speed is higher than own vehicle speed, the other vehicle speed being a speed of the other vehicle, the own vehicle speed being a speed of the own vehicle, the hands-on request requesting transition to a hands-on state in which the driver is holding the steering wheel.

### BRIEF DESCRIPTION OF THE DRAWINGS

FIG. 1 is a block diagram of a vehicle.

FIG. 2 is a flowchart illustrating a procedure of a hands-on request.

FIG. 3 is a flowchart illustrating a procedure of a target vehicle determination.

FIG. 4 is a flowchart illustrating a procedure of a reset condition determination.

FIG. 5 is a flowchart illustrating a procedure of a detection history determination.

FIG. 6 is a flowchart illustrating a procedure of a hands-on request determination.

FIG. 7 is a schematic diagram illustrating an output mode of the hands-on request.

### DETAILED DESCRIPTION OF THE PREFERRED EMBODIMENTS

In PTL 1, the hands-on request requests a driver to switch a hands-off state to a hands-on state. In the hands-off state, the driver is not holding a steering wheel. In the hands-on state, the driver is holding the steering wheel. The future lateral acceleration is undergone by a vehicle when the vehicle travels in a curve in the hands-off state. According to PTL 1, it is possible to continue the hands-off state and prevent an unnecessary hands-on request from being made in a case where the vehicle undergoes small lateral acceleration, for example, when traveling at low speed in a traffic jam.

[PTL 1] WO 2023/100469

Incidentally, when hands-off control that drives an own vehicle in the hands-off state is continued in a case where another vehicle is traveling in an adjacent lane at speed higher than the speed of the own vehicle, a situation in which the other vehicle in the adjacent lane overtakes the own vehicle that is in the hands-off state is caused, which is undesirable.

The present disclosure has been devised to solve the problem described above. A main object of the present disclosure is for a vehicle control device that performs hands-off control to avoid a situation in which another vehicle in an adjacent lane overtakes an own vehicle that is in a hands-off state.

A means for solving the problem described above is as below.

A vehicle control device is applicable to a vehicle including a steering wheel, an adjacent lane sensor, and a notification device. The adjacent lane sensor detects another vehicle traveling in an adjacent lane that is adjacent to an own vehicle lane in which an own vehicle is traveling. The notification device notifies a request to a driver of the own vehicle. The vehicle control device performs hands-off control that causes the own vehicle to travel in a hands-off state in which the driver is not holding the steering wheel. The vehicle control device outputs a hands-on request to the notification device on a basis that the hands-off control is being performed and other vehicle speed is higher than own vehicle speed, the other vehicle speed being a speed of the other vehicle detected by the adjacent lane sensor, the own vehicle speed being a speed of the own vehicle, the hands-on request requesting transition to a hands-on state in which the driver is holding the steering wheel.

According to the configuration, the vehicle control device is applicable to the vehicle including the steering wheel, the adjacent lane sensor, and the notification device and performs the hands-off control that causes the own vehicle to travel in the hands-off state.

Here, when the hands-off control is continued in a case where the other vehicle is traveling in the adjacent lane at the other vehicle speed which is higher than the own vehicle speed, a situation in which the other vehicle in the adjacent lane overtakes the own vehicle that is in the hands-off state is caused, which is undesirable. In this regard, the vehicle control device outputs the hands-on request to the notification device on the basis that the hands-off control is currently being performed and the other vehicle speed of the other vehicle sensed by the adjacent lane sensor is higher than the own vehicle speed. The notification device then notifies the hands-on request to the driver. It is thus possible to encourage the driver to transition to the hands-on state and avoid the situation in which the other vehicle in the adjacent lane overtakes the own vehicle that is in the hands-off state.

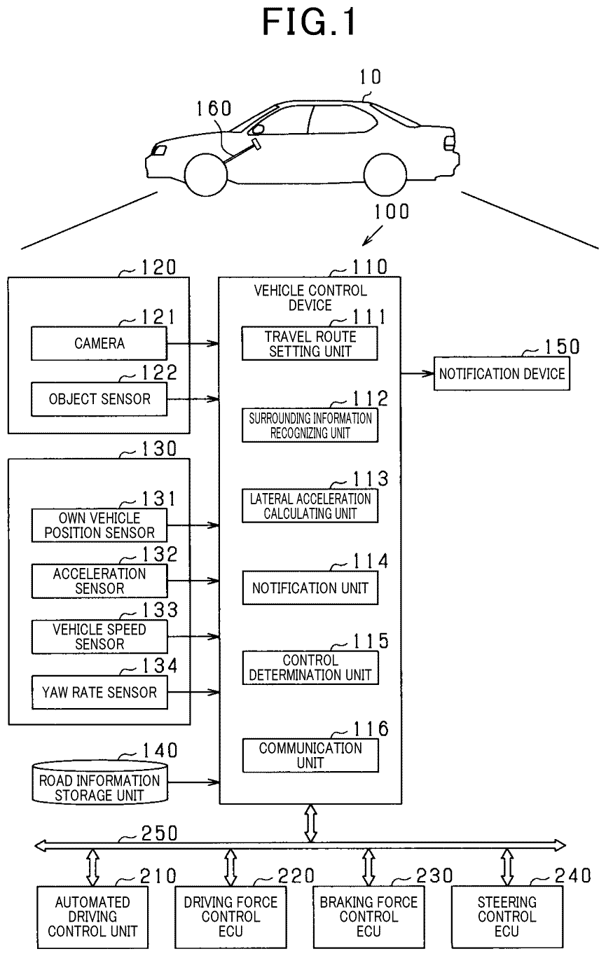

Hereinafter, an embodiment of a vehicle control device applicable to a vehicle will be described based on FIGS. 1 to 7.

### Configuration of Vehicle Control Device 110

As illustrated in FIG. 1, a vehicle 10 (also referred to as “an own vehicle 10” below) includes an automated driving control system 100, a steering wheel 160, and a notification device 150. The vehicle 10 is capable of automated driving and human driving. In automated driving, the vehicle 10 is automatedly steered and driven even though the steering wheel 160 for a driving operation on the vehicle 10 is not operated by a driver. In addition, automated driving also has a mode in which a driver takes charge of steering and acceleration and deceleration are automatedly controlled. In human driving, the steering wheel 160 is operated by a driver to steer and drive the vehicle 10.

In the present embodiment, the automated driving control system 100 includes a vehicle control device 110, a surrounding sensor 120, an internal sensor 130, a road information storage unit 140, an automated driving control unit 210, a driving force control ECU (Electronic Control Unit) 220, a braking force control ECU 230, and a steering control ECU 240. The vehicle control device 110, the automated driving control unit 210, the driving force control ECU 220, the braking force control ECU 230, and the steering control ECU 240 are connected through an vehicle-mounted network 250.

The surrounding sensor 120 (corresponding to an adjacent lane sensor) obtains surrounding information about the outside of the vehicle necessary for automated driving. The surrounding sensor 120 includes, for example, a camera 121 and an object sensor 122. The camera 121 images the region around the own vehicle 10 to obtain an image. The object sensor 122 detects the situation around the own vehicle 10. Examples of the object sensor 122 include object sensors such as a laser radar, a millimeter wave radar, and an ultrasonic wave sensor that use reflected waves. The surrounding sensor 120 detects another vehicle traveling in an adjacent lane that is adjacent to an own vehicle lane in which the vehicle 10 is traveling.

The internal sensor 130 includes an own vehicle position sensor 131, an acceleration sensor 132, a vehicle speed sensor 133, and a yaw rate sensor 134. The own vehicle position sensor 131 detects the current position of the vehicle 10. Examples of the own vehicle position sensor 131 include a global navigation satellite system(s) (GNSS), a gyro sensor, and the like.

The acceleration sensor 132 detects the acceleration of the vehicle 10. The acceleration sensor 132 includes, for example, a longitudinal acceleration sensor that detects the longitudinal acceleration of the vehicle 10 in the longitudinal direction and a lateral acceleration sensor that detects the lateral acceleration of the vehicle 10. The vehicle speed sensor 133 detects the current speed (referred to as “own vehicle speed V1” below) of the vehicle 10. The yaw rate sensor 134 detects the yaw rate (angular speed of rotation) of the vehicle 10 around the vertical axis at the center of gravity. It is possible to use, for example, a gyro sensor as the yaw rate sensor 134. The surrounding sensor 120 and the internal sensor 130 input the various kinds of obtained data to the vehicle control device 110.

The road information storage unit 140 stores detailed road information or the like regarding a road in which the vehicle 10 is scheduled to travel. The road information includes, for example, pieces of information about the number of lanes, the width of a lane, the central coordinates of each lane, the position of a stop line, the position of a traffic light, the position of a guardrail, a road grade, the road type of a curve or a straight section, the radius of curvature of a curve, the length of a curved section, and the like.

The notification device 150 is a device that notifies various kinds of information to an occupant (chiefly a driver) of the vehicle 10 using an image and/or sound. The notification device 150 includes a display device and a speaker. It is possible to use, for example, a HUD (Head-Up Display) and a display device provided to the instrument panel as the display device. It is to be noted that “image” may include a moving image or a character string.

The vehicle control device 110 includes a travel route setting unit 111, a surrounding information recognizing unit 112, a lateral acceleration calculating unit 113, a notification unit 114, a control determination unit 115, and a communication unit 116. The vehicle control device 110 includes a microcomputer and the like. The microcomputer includes a central processing unit (CPU), a RAM, and a ROM. The microcomputer executes programs installed in advance to implement the functions of these respective units. Some or all of the functions of these respective units may be, however, implemented by a hardware circuit.

The travel route setting unit 111 sets a route on which the vehicle 10 travels. More specifically, the travel route setting unit 111 sets a target travel route to a destination determined in advance using road information stored in the road information storage unit 140. The “target travel route” according to the present embodiment is not just a course to the destination. As the “target travel route” according to the present embodiment, a detailed route is indicated such as a travel lane or a travel position in a road.

The surrounding information recognizing unit 112 recognizes the surrounding information about the vehicle 10 using a detection signal of the surrounding sensor 120. More specifically, the surrounding information recognizing unit 112 recognizes the presence and the positions of the left and right lane lines (referred to as “lane markers” below) of the road in which the vehicle 10 is traveling, the presence, the position, and the instruction of a traffic light, the presence, the position, the size, the distance, the traveling direction, and the speed (referred to as “other vehicle speed V2” below) of another vehicle, the presence and the operation of the driver of another vehicle, the presence and the position of a person around another vehicle, and the like as the pieces of surrounding information based on an image captured by the camera 121 and an output signal of the object sensor 122. It is to be noted that the surrounding information recognizing unit 112 may obtain and recognize some or all of these pieces of information through wireless communication with a traffic light, an external server, or the like.

The lateral acceleration calculating unit 113 calculates future lateral acceleration undergone by the vehicle 10 when the vehicle 10 travels in a curve present in the traveling direction. Specifically, the lateral acceleration calculating unit 113 calculates future lateral acceleration during curve traveling based on the curvature of the curve and the vehicle speed of the vehicle 10.

The notification unit 114 notifies, to an occupant, various kinds of information such as a travel route, vehicle position information, and a request to the occupant using the notification device 150 capable of displaying an image and outputting sound. Depending on the driving situation of the vehicle 10, the notification unit 114 outputs a hands-on request to the notification device 150 (inputs a hands-on request to the notification device 150) in accordance with a process by the control determination unit 115. The hands-on request requests a hands-off state to be switched to a hands-on state (transition to the hands-on state) while automated driving (corresponding to hands-off control) in the hands-off state is currently being performed. The hands-off state is a state in which a driver is not holding the steering wheel 160. The hands-on state is a state in which a driver is holding the steering wheel 160.

The control determination unit 115 determines the content of control over the vehicle 10 depending on a result of the calculation of the lateral acceleration calculating unit 113 and outputs the content of control to the automated driving control unit 210 through the vehicle-mounted network 250 to control the vehicle 10. The communication unit 116 obtains, for example, traffic information, weather information, accident information, obstacle information, traffic regulation information, and the like from an unillustrated information center through an unillustrated antenna. The communication unit 116 may obtain various kinds of information from other vehicles through vehicle-to-vehicle communication. In addition, the communication unit 116 may obtain various kinds of information from a roadside unit provided at each of spots along a road through road-to-vehicle communication. The control determination unit 115 performs hands-off control under the condition that the vehicle 10 is traveling in an expressway (a road exclusively for motor vehicles) and the own vehicle speed V1 is lower than a predetermined speed Vt (e.g., 40 km/h). It is possible to recognize that the vehicle 10 is traveling in an expressway based on a result detected by the own vehicle position sensor 131 and road information stored in the road information storage unit 140. The hands-off control controls the own vehicle 10 to travel, for example, such that the travel lane in which the own vehicle 10 is currently traveling is kept and the distance between a preceding vehicle and the own vehicle 10 is kept constant.

The automated driving control unit 210 includes a microcomputer and the like. The microcomputer includes a central processing unit (CPU), a RAM, and a ROM. The microcomputer executes a program installed in advance to implement the automated driving function. The automated driving control unit 210 controls the driving force control ECU 220 and the braking force control ECU 230, and the steering control ECU 240, for example, to travel along a route decided by the travel route setting unit 111. For example, in a case where the vehicle 10 changes into a next lane (corresponding to an adjacent lane), the automated driving control unit 210 may deliver merging support such that the vehicle 10 travels to a reference line of the next lane from a reference line of the lane in which the vehicle 10 is traveling.

The driving force control ECU 220 is an electronic control unit that controls an actuator such as an engine which generates driving force for the vehicle 10. In a case where a driver performs human driving, the driving force control ECU 220 controls a power source that is an engine or an electric motor in response to the amount of operation on the accelerator pedal. Meanwhile, in a case where automated driving is performed, the driving force control ECU 220 controls the power source in response to required driving force calculated by the automated driving control unit 210.

The braking force control ECU 230 is an electronic control unit that controls a brake actuator which generates braking force for the vehicle 10. In a case where a driver performs human driving, the braking force control ECU 230 controls the brake actuator in response to the amount of operation on the brake pedal. Meanwhile, in a case where automated driving is performed, the braking force control ECU 230 controls the brake actuator in response to required braking force calculated by the automated driving control unit 210.

The steering control ECU 240 is an electronic control unit that controls a motor which generates steering torque for the vehicle 10. In a case where a driver performs human driving, the steering control ECU 240 controls the motor in response to an operation on the steering wheel and generates assist torque corresponding to the steering operation. This allows the driver to operate the steering wheel with less force and steer the vehicle 10. Meanwhile, in a case where automated driving is performed, the steering control ECU 240 controls the motor in response to a required steering angle calculated by the automated driving control unit 210, thereby achieving steering.

### Process by Vehicle Control Device 110

In automated driving, the travel route setting unit 111 creates a travel plan of the vehicle 10 up to several seconds ahead based on the current position detected by the own vehicle position sensor 131 and the position, the speed, or the like of another vehicle or the like around the vehicle 10. This travel plan includes a steering plan, an acceleration and deceleration plan, and the like of the vehicle 10 up to several seconds ahead.

Incidentally, when hands-off control is continued in a case where another vehicle is traveling in an adjacent lane at the other vehicle speed V2 which is higher than the own vehicle speed V1 of the own vehicle 10, a situation in which the other vehicle in the adjacent lane overtakes the own vehicle 10 that is in the hands-off state is caused, which is undesirable.

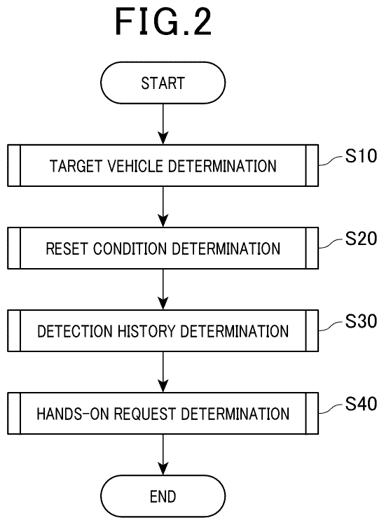

Accordingly, the vehicle control device 110 outputs a hands-on request in accordance with the procedure illustrated in the flowchart of FIG. 2. This series of processes is repeatedly performed by the vehicle control device 110 in a predetermined periodicity while hands-off control is currently being performed. In addition, this series of processes is performed for both the left adjacent lane and the right adjacent lane of the vehicle 10.

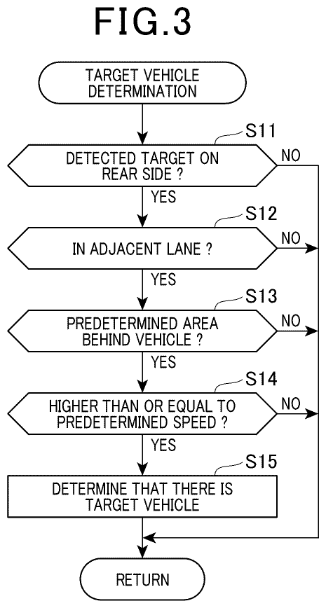

First, it is determined whether there is a target vehicle in an adjacent lane (S10). If described in detail, it is determined whether there is a detected target on a rear side of the own vehicle 10 based on a result detected by the surrounding sensor 120 as illustrated in FIG. 3 (S11). In a case where it is determined that there is a detected target on a rear side of the own vehicle 10 (S11: YES), it is determined whether the detected target is located in an adjacent lane based on a result detected by the surrounding sensor 120 and road information stored in the road information storage unit 140 (S12). In a case where it is determined that the detected target is located in an adjacent lane (S12: YES), it is determined whether the detected target is located in a predetermined area behind the own vehicle 10 based on a result detected by the surrounding sensor 120 (S13). In a case where it is determined that the detected target is located in a predetermined area behind the own vehicle 10 (S13: YES), it is determined whether the speed of the detected target is higher than or equal to the predetermined speed Vt based on a result detected by the surrounding sensor 120 and a result detected by the vehicle speed sensor 133 (S14). Hands-off control is performed under the condition that the own vehicle speed V1 is lower than the predetermined speed Vt. The speed of the detected target being higher than or equal to the predetermined speed Vt thus corresponds to the other vehicle speed V2 being higher than the own vehicle speed V1. In a case where it is determined that the speed of the detected target is higher than or equal to the predetermined speed Vt (S14: YES), it is determined that there is a target vehicle (S15). In contrast, in a case where the determination of any of S11 to S14 results in a negative determination, it is not determined that there is a target vehicle. After that, the flow returns to FIG. 2 and advances to the process of S20.

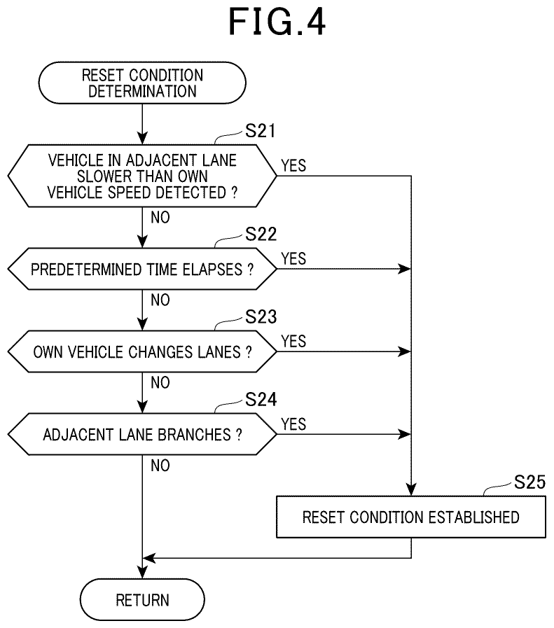

Subsequently, it is determined whether a reset condition is established (S20). If described in detail, it is determined whether another vehicle in an adjacent lane slower than the own vehicle speed V1 has been detected based on a result detected by the surrounding sensor 120 and a result detected by the vehicle speed sensor 133 as illustrated in FIG. 4 (S21). In a case where it is determined that another vehicle in an adjacent lane slower than the own vehicle speed V1 is not detected (S21: NO), it is determined whether a predetermined time elapses after it is determined that there is a target vehicle (S22). In a case where it is determined that a predetermined time does not elapse after it is determined that there is a target vehicle (S22: NO), it is determined whether the own vehicle 10 changes lanes (i.e., moves to an adjacent lane) after hands-off control is started based on a result detected by the surrounding sensor 120 or the like (S23). In a case where it is determined that the own vehicle 10 does not change lanes after hands-off control is started (S23: NO), it is determined whether the adjacent lane branches based on at least one of a result detected by the camera 121 and road information stored in the road information storage unit 140 (S24). In a case where it is determined that the adjacent lane does not branch (S24: NO), it is not determined that the reset condition is established. In contrast, in a case where the determination of any of S21 to S24 results in an affirmative determination, it is determined that the reset condition is established (S25). That is, in a case where another vehicle having the other vehicle speed V2 which is lower than the own vehicle speed V1 has been detected after another vehicle having the other vehicle speed V2 which is higher than the own vehicle speed V1 is detected and before another vehicle coming next and having the other vehicle speed V2 which is higher than the own vehicle speed V1 is detected, it is determined that the reset condition is established. In addition, in a case where a predetermined time elapses without detecting, consecutively within a predetermined time, a predetermined number of other vehicles or more each having the other vehicle speed V2 which is higher than the own vehicle speed V1 in an adjacent lane, the output of the hands-on request to the notification device 150 is stopped. After that, the flow returns to FIG. 2 and advances to the process of S30.

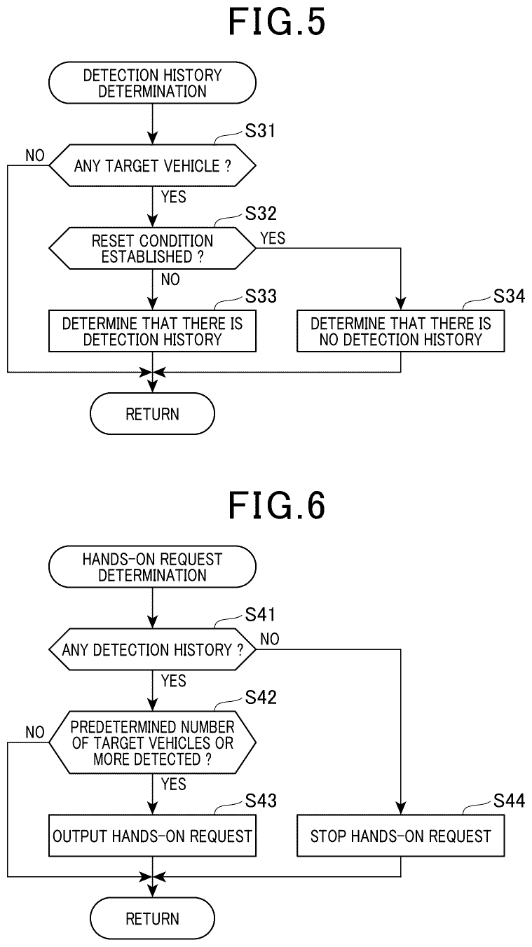

Subsequently, it is determined whether there is a detection history of a target vehicle (S30). If described in detail, it is determined as illustrated in FIG. 5 whether the determination result of the process of S10 in FIG. 2 indicates that there is a target vehicle (S31). In a case where it is determined that the determination result of S10 indicates that there is a target vehicle (S31: YES), it is determined whether the determination result of the process of S20 in FIG. 2 indicates that the reset condition is established (S32). In a case where it is determined that the determination result of S20 does not indicate that the reset condition is established (S32: NO), it is determined that there is a detection history (S33). In contrast, in a case where it is determined that the determination result of S20 indicates that the reset condition is established (S32: YES), it is determined that there is no detection history and the result of the determination that there is a target vehicle is reset (S34). After that, the flow returns to FIG. 2 and advances to the process of S40. In addition, in a case where it is determined that the determination result of S10 does not indicate that there is a target vehicle (S31: NO), the flow returns to FIG. 2 and advances to the process of S40.

Subsequently, it is determined whether to output a hands-on request (S40). If described in detail, it is determined as illustrated in FIG. 6 whether the determination result of the process of S30 in FIG. 2 indicates that there is a detection history (S41). In a case where it is determined that the determination result of S30 does not indicate that there is a detection history (S41: NO), the output of the hands-on request to the notification device 150 is stopped (S44). After that, the flow returns to FIG. 2 and brings this series of processes to an end temporarily (END). In contrast, in a case where it is determined that the determination result of S30 indicates that there is a detection history (S41: YES), it is determined whether a predetermined number of target vehicles or more have been detected within a predetermined time after it is determined that there is a target vehicle (S42). It is possible to adjust as appropriate the predetermined time and the predetermined number of target vehicles. In the case of an affirmative determination (S42: YES), a hands-on request is output to the notification device 150 (S43). That is, in a case where the predetermined number of other vehicles or more each having the other vehicle speed V2 which is higher than the own vehicle speed V1 have been detected consecutively in an adjacent lane within the predetermined time, a hands-on request is output to the notification device 150. In contrast, in the case of a negative determination (S42: NO), the flow returns to FIG. 2 and brings this series of processes to an end temporarily (END).

In addition, in a case where a hands-on request is output for one of the left adjacent lane and the right adjacent lane of the vehicle 10, the vehicle control device 110 outputs a hands-on request regardless of the presence or absence of a hands-on request for the other lane. Therefore, in a case where a hands-on request is output for at least one of the left adjacent lane and the right adjacent lane of the vehicle 10, the notification device 150 notifies a hands-on request.

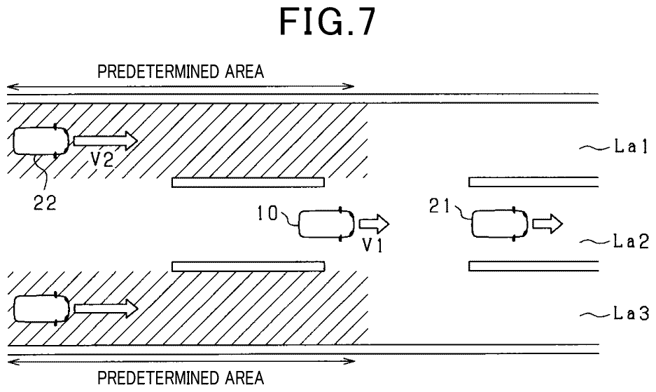

FIG. 7 is a schematic diagram illustrating an output mode of a hands-on request. Here, the own vehicle 10 is traveling in a lane La2 of an expressway. There is a traffic jam in the lane La2 and a preceding vehicle 21 is traveling ahead of the own vehicle 10. The own vehicle 10 is performing automated driving in accordance with hands-off control. The own vehicle speed V1 of the own vehicle 10 is lower than the predetermined speed Vt. There is no traffic jam in a lane La1 and another vehicle 22 is traveling in a predetermined area on the rear left of the own vehicle 10. The other vehicle speed V2 of the other vehicle 22 is higher than the predetermined speed Vt. In this case, the vehicle control device 110 determines that there is a target vehicle, determines that the reset condition is not established, and determines that there is a detection history.

In a case where a predetermined number of target vehicles or more are detected in the lane La1 until it is determined that there is no detection history, the vehicle control device 110 outputs a hands-on request to the notification device 150. Upon receiving the hands-on request from the vehicle control device 110, the notification device 150 notifies the hands-on request to an occupant of the vehicle 10 using an image or sound. Additionally, in a case where a driver does not respond to the hands-on request, the vehicle control device 110 stops the hands-off control and causes the vehicle 10 to perform an evasive travel.

In addition, in a case where it is determined that the reset condition is established, the vehicle control device 110 determines that there is no detection history and stops the output of the hands-on request to the notification device 150. It is to be noted that the vehicle control device 110 similarly makes a determination about a hands-on request for a lane La3.

The present embodiment described in detail so far has the following advantages.
The vehicle control device 110 outputs a hands-on request to the notification device 150 on the basis that hands-off control is currently being performed and the other vehicle speed V2 is higher than the own vehicle speed V1. The notification device 150 then notifies the hands-on request to a driver. It is thus possible to encourage the driver to transition to the hands-on state and avoid the situation in which the other vehicle 22 in the adjacent lane overtakes the own vehicle 10 that is in the hands-off state.
In a case where the predetermined number of other vehicles 22 or more each having the other vehicle speed V2 which is higher than the own vehicle speed V1 are detected consecutively in the lane La1 (adjacent lane) within the predetermined time, the vehicle control device 110 outputs a hands-on request to the notification device 150. It is therefore possible to output a hands-on request in a case where a situation in which the other vehicle 22 in the lane La1 overtakes the own vehicle 10 that is in the hands-off state continues, for example, in a case where a situation in which there is a traffic jam in the lane La2 (own vehicle lane) and there is no traffic jam in the lane La1 continues. In contrast, in a case where the predetermined number of other vehicles 22 or more each having the other vehicle speed V2 which is higher than the own vehicle speed V1 are not detected consecutively in the lane La1 within the predetermined time, the vehicle control device 110 stops the output of the hands-on request to the notification device 150. In spite of a temporary situation in which the other vehicle 22 in the lane La1 overtakes the own vehicle 10 that is in the hands-off state, it is therefore possible to prevent an unnecessary hands-on request to be output in a case where that situation does not continue.
In a case where the other vehicle 22 having the other vehicle speed V2 which is lower than the own vehicle speed V1 is detected after the other vehicle 22 having the other vehicle speed V2 which is higher than the own vehicle speed V1 is detected and before the other vehicle 22 coming next and having the other vehicle speed V2 which is higher than own vehicle speed V1 is detected, the vehicle control device 110 stops the output of the hands-on request to the notification device 150. Such a configuration makes it possible to grasp that the situation in which the other vehicle 22 in the lane La1 overtakes the own vehicle 10 which is in the hands-off state is interrupted on the basis that the other vehicle 22 having the other vehicle speed V2 which is lower than the own vehicle speed V1 is detected, and stop the output of the hands-on request to the notification device 150.
The vehicle control device 110 stops the output of the hands-on request to the notification device 150 in a case where the own vehicle 10 moves to the lane La1 or the lane La3 (adjacent lane). Such a configuration makes it possible to stop the output of the hands-on request to the notification device 150 in a case where the own vehicle 10 moves to an adjacent lane and the surrounding situation of the own vehicle 10 changes. It is thus possible to prevent an unnecessary hands-on request from being output to the notification device 150.
The vehicle control device 110 performs hands-off control under the condition that the own vehicle speed V1 is lower than the predetermined speed Vt. The own vehicle speed V1 is therefore lower than the predetermined speed Vt as long as hands-off control is being performed. It is thus possible for the vehicle control device 110 to easily grasp that the other vehicle speed V2 is higher than the own vehicle speed V1 by considering the other vehicle speed V2 to be higher than the own vehicle speed V1 in a case where the other vehicle speed V2 is higher than or equal to the predetermined speed Vt.

Additionally, it is also possible to modify and carry out the embodiment as below. The same portions as those of the embodiment will be denoted with the same reference signs and the description thereof will be thus incorporated.
Instead of the process of S14 in FIG. 3, the vehicle control device 110 may determine whether the other vehicle speed V2 is higher than the own vehicle speed V1.
It is also possible to skip some of the processes of S21 to S24 in FIG. 4.
When the vehicle 10 is traveling in a curve, a process of the flowchart of FIG. 3 may be performed by taking the curvature of the curve into consideration. It is possible to calculate the curvature of a curve, for example, based on at least one of a result detected by the camera 121 and road information stored in the road information storage unit 140.

Additionally, it is also possible to execute the embodiment and the respective modification examples in combination within a combinable range.

Hereinafter, characteristic configurations extracted from the respective embodiments and the respective modification examples described above will be described.

### Configuration 1

A vehicle control device applicable to a vehicle including a steering wheel, an adjacent lane sensor, and a notification device, the adjacent lane sensor detecting another vehicle traveling in an adjacent lane that is adjacent to an own vehicle lane in which an own vehicle is traveling, the notification device notifying a request to a driver of the own vehicle, in which
the vehicle control device comprising:
at least one of (i) a circuit and (ii) a processor with a memory storing computer program code executable by the processor, the at least one of the circuit and the processor configured to cause the vehicle control device to:
perform hands-off control that causes the own vehicle to travel in a hands-off state in which the driver is not holding the steering wheel; and
output a hands-on request to the notification device on a basis that (i) the hands-off control is being performed and (ii) other vehicle speed is higher than own vehicle speed, the other vehicle speed being a speed of the other vehicle detected by the adjacent lane sensor, the own vehicle speed being a speed of the own vehicle, the hands-on request requesting transition to a hands-on state in which the driver is holding the steering wheel.

### Configuration 2

The vehicle control device according to Configuration 1, in which the at least one of the circuit and the processor is further configured to cause the vehicle control device to
output the hands-on request to the notification device in a case where a predetermined number of other vehicles or more each having the other vehicle speed which is higher than the own vehicle speed are detected consecutively in the adjacent lane within a predetermined time; and
stop an output of the hands-on request to the notification device in a case where the predetermined number of other vehicles or more each having the other vehicle speed which is higher than the own vehicle speed are not detected consecutively in the adjacent lane within the predetermined time.

### Configuration 3

The vehicle control device according to Configuration 1 or 2, in which the at least one of the circuit and the processor is further configured to cause the vehicle control device to stop an output of the hands-on request to the notification device in a case where another vehicle having the other vehicle speed which is lower than the own vehicle speed is detected after another vehicle having the other vehicle speed which is higher than the own vehicle speed is detected and before another vehicle coming next and having the other vehicle speed which is higher than the own vehicle speed is detected.

### Configuration 4

The vehicle control device according to any one of Configurations 1 to 3, in which the at least one of the circuit and the processor is further configured to cause the vehicle control device to stop an output of the hands-on request to the notification device in a case where the own vehicle moves to the adjacent lane.

### Configuration 5

The vehicle control device according to any one of Configurations 1 to 4, in which the at least one of the circuit and the processor is further configured to cause the vehicle control device to perform the hands-off control under a condition that the own vehicle speed is lower than a predetermined speed, and the other vehicle speed is determined to be higher than the own vehicle speed in a case where the other vehicle speed is higher than or equal to the predetermined speed.

### Configuration 6

A vehicle including:
the vehicle control device according to any one of Configurations 1 to 5;
the steering wheel;
the adjacent lane sensor; and
the notification device.

### Configuration 7

A vehicle control method for a vehicle including a steering wheel, an adjacent lane sensor, and a notification device, the adjacent lane sensor detecting another vehicle traveling in an adjacent lane that is adjacent to an own vehicle lane in which an own vehicle is traveling, the notification device notifying a request to a driver of the own vehicle, in which
the vehicle control method comprising:
performing hands-off control that causes the own vehicle to travel in a hands-off state in which the driver is not holding the steering wheel; and
outputting a hands-on request to the notification device on a basis that (i) the hands-off control is being performed and (ii) other vehicle speed is higher than own vehicle speed, the other vehicle speed being a speed of the other vehicle detected by the adjacent lane sensor, the own vehicle speed being a speed of the own vehicle, the hands-on request requesting transition to a hands-on state in which the driver is holding the steering wheel.

What is claimed is:

1. A vehicle control device applicable to a vehicle including a steering wheel, an adjacent lane sensor, and a notification device, the adjacent lane sensor detecting another vehicle traveling in an adjacent lane that is adjacent to an own vehicle lane in which an own vehicle is traveling, the notification device notifying a request to a driver of the own vehicle, wherein
the vehicle control device comprising:
at least one of (i) a circuit and (ii) a processor with a memory storing computer program code executable by the processor, the at least one of the circuit and the processor configured to cause the vehicle control device to:
perform hands-off control that causes the own vehicle to travel in a hands-off state in which the driver is not holding the steering wheel; and
output a hands-on request to the notification device on a basis that (i) the hands-off control is being performed and (ii) other vehicle speed is higher than own vehicle speed, the other vehicle speed being a speed of the other vehicle detected by the adjacent lane sensor, the own vehicle speed being a speed of the own vehicle, the hands-on request requesting transition to a hands-on state in which the driver is holding the steering wheel.

2. The vehicle control device according to claim 1, wherein the at least one of the circuit and the processor is further configured to cause the vehicle control device to
output the hands-on request to the notification device in a case where a predetermined number of other vehicles or more each having the other vehicle speed which is higher than the own vehicle speed are detected consecutively in the adjacent lane within a predetermined time; and
stop an output of the hands-on request to the notification device in a case where the predetermined number of other vehicles or more each having the other vehicle speed which is higher than the own vehicle speed are not detected consecutively in the adjacent lane within the predetermined time.

3. The vehicle control device according to claim 1, wherein the at least one of the circuit and the processor is further configured to cause the vehicle control device to stop an output of the hands-on request to the notification device in a case where another vehicle having the other vehicle speed which is lower than the own vehicle speed is detected after another vehicle having the other vehicle speed which is higher than the own vehicle speed is detected and before another vehicle coming next and having the other vehicle speed which is higher than the own vehicle speed is detected.

4. The vehicle control device according to claim 1, wherein the at least one of the circuit and the processor is further configured to cause the vehicle control device to stop an output of the hands-on request to the notification device in a case where the own vehicle moves to the adjacent lane.

5. The vehicle control device according to claim 1, wherein
the at least one of the circuit and the processor is further configured to cause the vehicle control device to perform the hands-off control under a condition that the own vehicle speed is lower than a predetermined speed, and
the other vehicle speed is determined to be higher than the own vehicle speed in a case where the other vehicle speed is higher than or equal to the predetermined speed.

6. A vehicle comprising:
the vehicle control device according to claim 1;
the steering wheel;
the adjacent lane sensor; and
the notification device.

7. A vehicle control method for a vehicle including a steering wheel, an adjacent lane sensor, and a notification device, the adjacent lane sensor detecting another vehicle traveling in an adjacent lane that is adjacent to an own vehicle lane in which an own vehicle is traveling, the notification device notifying a request to a driver of the own vehicle, wherein
the vehicle control method comprising:
performing hands-off control that causes the own vehicle to travel in a hands-off state in which the driver is not holding the steering wheel; and
outputting a hands-on request to the notification device on a basis that (i) the hands-off control is being performed and (ii) other vehicle speed is higher than own vehicle speed, the other vehicle speed being a speed of the other vehicle detected by the adjacent lane sensor, the own vehicle speed being a speed of the own vehicle, the hands-on request requesting transition to a hands-on state in which the driver is holding the steering wheel.
